(19) United States
(12) Patent Application Publication
(10) Pub. No.: US 2025/0279655 A1
(43) Pub. Date: Sep. 4, 2025

(54) LIFE-EXTENDED ACTIVE BATTERY CONTROL FOR ENERGY STORAGE USING ELECTRIC VEHICLE RETIRED BATTERIES

(71) Applicants: Hongjie Wang, North Logan, UT (US); Regan A. Zane, Hyde Park, UT (US)

(72) Inventors: Hongjie Wang, North Logan, UT (US); Regan A. Zane, Hyde Park, UT (US)

(73) Assignee: Utah State University, Logan, UT (US)

(21) Appl. No.: 18/604,334

(22) Filed: Mar. 13, 2024

Related U.S. Application Data
(60) Provisional application No. 63/560,622, filed on Mar. 1, 2024.

(51) Int. Cl. H02J 7/00; H01M 10/42; H01M 10/48; H02J 1/14

(52) U.S. Cl. CPC H02J 7/0014; H01M 10/425; H01M 10/482; H02J 1/14; H02J 7/0048; H01M 2010/4271; H01M 2220/20; H02J 2207/20

(57) ABSTRACT

An apparatus for extending battery life includes a control objective map module configured to derive a mapping between a state of charge (“SOC”) of each battery unit of a plurality of battery units with respect to an average SOC of the battery units. A highest capacity battery unit has a highest discharge amount between a SOC maximum and a SOC minimum and a lowest capacity battery unit has a lowest discharge amount between the SOC maximum and the SOC minimum. Each battery unit is connected to a shared bus through a direct current (“DC”) to DC power converter. The control objective map provides a current reference for a battery unit of the plurality of battery units in relation to a common current of the shared bus. The current reference for the battery unit includes a reference current for the DC to DC power converter connected to the battery unit.

### CROSS-REFERENCES TO RELATED APPLICATIONS

This application claims the benefit of U.S. Provisional Patent Application No. 63/560,622 entitled “LIFE-EXTENDED ACTIVE BATTERY CONTROL FOR ENERGY STORAGE USING ELECTRIC VEHICLE RETIRED BATTERIES” and filed on Mar. 1, 2024 for Hongjie Wang et al., which is incorporated herein by reference.

### FIELD

This invention relates to control of battery charging and more particularly relates to life-extended active battery control for energy storage using retired batteries with different capacities.

### BACKGROUND

As the progress toward net-zero carbon emissions keeps accelerating, electrified transportation is becoming the dominant driver for lithium-ion (Li-ion) battery adoption. It is estimated that more than 200 giga-watt-hours (“GWh”) of an annual supply of Li-ion batteries will be available for a second life use by 2030. During the same period, the demand for stationary battery energy storage systems (“BESS”) is expected to grow from 10 GWh in 2020 to more than 200 GWh in 2030, including grid-scale BESS and BESS required for electric vehicle (“EV”) charging infrastructure. Repurposing EV-retired batteries for a second life use in stationary BESS will solve the challenges on both sides, bring significant socio-economic and environmental benefits, and facilitate the goal of net-zero carbon emissions.

Since the EV-retired batteries still hold up to 70% to 80% of their nameplate capacities and can satisfy the energy storage needs required by the stationary BESS, the second use of EV-retired batteries in stationary BESS is promising. A key challenge is that the EV-retired batteries tend to not only have a differential state of health (“SOH”) but to have initiated SOH deterioration at differential rates. Active battery control can solve the challenges and potentially enable the direct use of EV-retired batteries in stationary BESS at a low cost.

### SUMMARY

An apparatus for extending the life of battery units includes a control objective map (“COM”) module configured to derive a mapping between a state of charge (“SOC”) of each battery unit of a plurality of battery units with respect to an average SOC of the plurality of battery units. A highest capacity battery unit of the plurality of battery units has a highest amount of discharge between a selected SOC maximum and a selected SOC minimum and a lowest capacity battery unit of the plurality of battery units has a lowest amount of discharge between the selected SOC maximum and the selected SOC minimum. Each battery unit of the plurality of battery units is connected to a shared bus through a direct current (“DC”) to DC power converter. The control objective map provides a current reference for a battery unit of the plurality of battery units in relation to a common current of the shared bus. The current reference for the battery unit includes a reference current for the DC to DC power converter connected to the battery unit. At least a portion of the modules include hardware circuits, programmable hardware circuits and/or executable code. The executable code stored on one or more computer readable storage media.

A system for extending the life of battery units includes a plurality of battery units, a plurality of DC to DC power converter, and a shared bus with a common current. The shared bus is configured to connect to one or more electrical devices and/or an electrical distribution system. Each battery unit of the plurality of battery units is connected to the shared bus through a DC to DC power converter of the plurality of DC to DC converters. The system includes a control objective map (“COM”) module configured to derive a mapping between a state of charge (“SOC”) of each battery unit of the plurality of battery units with respect to an average SOC of the plurality of battery units. A highest capacity battery unit of the plurality of battery units has a highest amount of discharge between a selected SOC maximum and a selected SOC minimum and a lowest capacity battery unit of the plurality of battery units has a lowest amount of discharge between the selected SOC maximum and the selected SOC minimum. The control objective map provides a current reference for a battery unit of the plurality of battery units in relation to the common current of the shared bus. The current reference for the battery unit includes a reference current for the DC to DC power converter connected to the battery unit.

Another apparatus for extending the life of battery units includes a control objective map (“COM”) module configured to derive a mapping between a state of charge (“SOC”) of each battery unit of a plurality of battery units with respect to an average SOC of the plurality of battery units. A highest capacity battery unit of the plurality of battery units has a highest amount of discharge between a selected SOC maximum and a selected SOC minimum and a lowest capacity battery unit of the plurality of battery units has a lowest amount of discharge between the selected SOC maximum and the selected SOC minimum. Each battery unit of the plurality of battery units connected to a shared bus through a DC to DC power converter. The system includes a delta max module configured to select a maximum SOC difference at the selected maximum SOC. The maximum SOC difference includes a difference between SOC for the highest capacity battery unit and a lowest capacity battery unit of the plurality of battery units at a selected maximum SOC for the plurality of battery units. The COM module includes a current reference module configured to derive the current reference for a battery unit of the plurality of battery units based on the maximum SOC difference, an average SOC for the plurality of battery units, the selected SOC maximum, the selected SOC minimum, a selected SOC midpoint for the plurality of battery units, a capacity of the highest capacity battery unit, a capacity of a lowest capacity battery unit, an average capacity of the plurality of battery units, a capacity of the battery unit, and a common current of the shared bus. The current reference for the battery unit of the plurality of battery units is in relation to a common current of the shared bus and the current reference for the battery unit includes a reference current for the DC to DC power converter connected to the battery unit.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A is a schematic block diagram illustrating a system for extending the life of battery units where the battery units are independent from each other, according to various embodiments;

FIG. 1B is a schematic block diagram illustrating a system for extending the life of battery units where the battery units are connected in series to form a high-voltage bus and DC to DC power converters connect to each battery unit to provide power to a low voltage bus, according to various embodiments;

FIG. 2 is a schematic block diagram illustrating an active battery balancing control (“ABBC”) for a battery unit, according to various embodiments;

FIG. 3 is a life-extended active battery control objective map, according to various embodiments;

FIG. 4 is a schematic block diagram illustrating an apparatus for extending the life of battery units, according to various embodiments;

FIG. 5 is a control objective map for an active battery balancing control when capacity differences between battery units are below a capacity threshold, according to various embodiments;

FIG. 6 is a schematic block diagram illustrating a system used for experimental results for demonstrating a system for extending the life of battery units, according to various embodiments;

FIG. 7A illustrates test results that include battery unit voltage, load current, balancing current, and state of charge;

FIG. 7B illustrates test results that include a common bus current, power, energy, and average state of charge; and

FIG. 8 illustrates initial battery capacities and test results indicating capacity imbalance decreases.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (“ISA”) instructions, machine instructions, machine dependent instructions, microcode, firmware instructions, state-setting data, or either source code or object code written in any combination of one or more programming languages, including an object oriented programming language such as Smalltalk, C++or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider). In some embodiments, electronic circuitry including, for example, programmable logic circuitry, field-programmable gate arrays (“FPGA”), or programmable logic arrays (“PLA”) may execute the computer readable program instructions by utilizing state information of the computer readable program instructions to personalize the electronic circuitry, in order to perform aspects of the present invention.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C.

Novel ideas on implementing active battery balancing control have been patented in U.S. Pat. No. 10,277,041 [hereinafter “the '041 patent”] and U.S. Pat. No. 10,063,066 [hereinafter “the '066 patent”], which are discussed below and are herein incorporated by reference for all purposes, including terminal voltage balancing control, state of charge (“SOC”) balancing control, and life balancing control, which may be used after capacities of battery units have equalized.

The embodiments described herein include further development and understanding of the active battery balancing control for the direct reuse of EV-retired batteries. Embodiments described herein, which have not been analyzed or demonstrated in the literature, include detailed analysis of BESS available power and energy when active life balancing control is applied, and experimental results from Nissan® Leaf® retired batteries to demonstrate the effectiveness of active battery control on extending the life of BESS using EV-retired batteries.

An apparatus for extending the life of battery units includes a control objective map (“COM”) module configured to derive a mapping between a state of charge (“SOC”) of each battery unit of a plurality of battery units with respect to an average SOC of the plurality of battery units. A highest capacity battery unit of the plurality of battery units has a highest amount of discharge between a selected SOC maximum and a selected SOC minimum and a lowest capacity battery unit of the plurality of battery units has a lowest amount of discharge between the selected SOC maximum and the selected SOC minimum. Each battery unit of the plurality of battery units is connected to a shared bus through a direct current (“DC”) to DC power converter. The control objective map provides a current reference for a battery unit of the plurality of battery units in relation to a common current of the shared bus. The current reference for the battery unit includes a reference current for the DC to DC power converter connected to the battery unit. At least a portion of the modules include hardware circuits, programmable hardware circuits and/or executable code. The executable code stored on one or more computer readable storage media.

In some embodiment, the apparatus includes a delta max module configured to select a maximum SOC difference at the selected maximum SOC. The maximum SOC difference includes a difference between SOC for the highest capacity battery unit and a lowest capacity battery unit of the plurality of battery units at a selected maximum SOC for the plurality of battery units. In other embodiments, the COM module includes a current reference module configured to derive the current reference for a battery unit of the plurality of battery units based on the maximum SOC difference, an average SOC for the plurality of battery units, the selected SOC maximum, the selected SOC minimum, a selected SOC midpoint for the plurality of battery units, a capacity of the highest capacity battery unit, a capacity of a lowest capacity battery unit, an average capacity of the plurality of battery units, a capacity of the battery unit, and a common current of the shared bus.

In other embodiments, the current reference for the battery unit is derived as:

$${I}_{j} = {I}_{c o m m o n} ( 1 + \frac{S O {C}_{e r ror , j}}{MAX ( \vert S O {C}_{e r ror , j} \vert )} ) ;$$

$$S O {C}_{error , j} = S O {C}_{error , j} - ( S O {C}_{a v g} + \frac{2 {Δ}_{max} ( {Q}_{j} - {Q}_{a v g} )}{{Q}_{max} - {Q}_{min}} ) {K}_{S O C} ;$$

$${K}_{S O C} = \frac{S O {C}_{a v g} - S O {C}_{m i d}}{S O {C}_{max} - S O {C}_{min}} ; and$$

$$S O {C}_{error , j} = S O {C}_{j} - S O {C}_{a v g} ;$$

where Δₘₐₓ is the maximum SOC difference, SOC_{avg} is the average SOC of plurality of battery units, SOC_{mid} is the selected SOC midpoint for the plurality of battery units, SOCₘₐₓ is the selected SOC maximum of plurality of battery units, SOCₘᵢₙ is the selected SOC minimum of plurality of battery units, SOCⱼ is the SOC of the battery unit, MAX(|SOC_{error,j}|) is the absolute value of a highest difference between an SOC of a battery unit of the plurality of battery units and SOC_{avg}, Qₘₐₓ is the capacity of the highest capacity battery unit, Qₘᵢₙ is the capacity of the lowest capacity battery unit, Q_{avg} is the average capacity of the plurality of battery units, Qⱼ is the capacity of the battery unit, and I_{common} is the common current of the shared bus.

Ion some embodiments, the COM module is configured so derive a mapping for the highest capacity battery unit and a mapping for the lowest capacity battery unit to have a state of charge difference matching the maximum SOC difference at the selected SOC maximum and at the selected SOC minimum and the COM module is further configured to derive a selected SOC midpoint where the SOC of each of the plurality of battery units are the same based on a calculated SOC trajectory for each of the plurality of battery units. In other embodiments, the COM module is configured so derive a mapping for the highest capacity battery unit and a mapping for the lowest capacity battery unit so that the SOC of the highest capacity battery unit has a highest SOC at the SOC maximum and has lowest SOC at the SOC minimum and the SOC of the lowest capacity battery unit has a lowest SOC at the SOC maximum and has highest SOC at the SOC minimum.

In some embodiments, the apparatus includes a capacity module configured to periodically calculate a capacity of each battery unit of the plurality of battery units based on an estimated SOC, a voltage, and a current of each of the plurality of battery units. In other embodiments, in response to calculating the capacity of each of the plurality of battery units, the delta max module adjusts the maximum SOC difference, the COM module re-derives the mapping between the SOC of each battery unit of the plurality of battery units and the average SOC. In other embodiments, the apparatus includes a capacity threshold module configured to determine if a difference between the capacity of the highest capacity battery unit of the plurality of battery units and the capacity of the lowest capacity battery unit of the plurality of battery units is less than a capacity threshold, and/or an SOC balancing module configured to input a common current reference at the DC to DC power converter of each battery unit of the plurality of battery units in response to the difference between the capacity of the highest capacity battery unit and the capacity of the lowest capacity battery unit being below the capacity threshold.

In other embodiments, the capacity module is further configured to use a nominal capacity for a battery unit of the plurality of battery units at a start of use of the battery unit. In other embodiments, the capacity module is further configured to calculate an initial capacity of a battery unit of the plurality of battery units prior to use of the battery unit. In other embodiments, each battery unit of the plurality of battery units is a used battery unit that was previously used for a different purpose. In other embodiments, the shared bus is connected to provide power to and receive power from one or more electrical devices and/or an electrical distribution system.

A system for extending the life of battery units includes a plurality of battery units, a plurality of DC to DC power converter, and a shared bus with a common current. The shared bus is configured to connect to one or more electrical devices and/or an electrical distribution system. Each battery unit of the plurality of battery units is connected to the shared bus through a DC to DC power converter of the plurality of DC to DC converters. The system includes a control objective map (“COM”) module configured to derive a mapping between a state of charge (“SOC”) of each battery unit of the plurality of battery units with respect to an average SOC of the plurality of battery units. A highest capacity battery unit of the plurality of battery units has a highest amount of discharge between a selected SOC maximum and a selected SOC minimum and a lowest capacity battery unit of the plurality of battery units has a lowest amount of discharge between the selected SOC maximum and the selected SOC minimum. The control objective map provides a current reference for a battery unit of the plurality of battery units in relation to the common current of the shared bus. The current reference for the battery unit includes a reference current for the DC to DC power converter connected to the battery unit.

In some embodiments, the system includes a delta max module configured to select a maximum SOC difference at the selected maximum SOC. The maximum SOC difference includes a difference between SOC for the highest capacity battery unit and a lowest capacity battery unit of the plurality of battery units at a selected maximum SOC for the plurality of battery units. In other embodiments, the COM module includes a current reference module configured to derive the current reference for a battery unit of the plurality of battery units based on the maximum SOC difference, an average SOC for the plurality of battery units, the selected SOC maximum, the selected SOC minimum, a selected SOC midpoint for the plurality of battery units, a capacity of the highest capacity battery unit, a capacity of a lowest capacity battery unit, an average capacity of the plurality of battery units, a capacity of the battery unit, and a common current of the shared bus.

In some embodiments, the system includes a capacity module configured to periodically calculate a capacity of each battery unit of the plurality of battery units based on an estimated SOC, a voltage, and a current of each of the plurality of battery units. In response to calculating the capacity of each of the plurality of battery units, the delta max module adjusts the maximum SOC difference, the COM module re-derives the mapping between the SOC of each battery unit of the plurality of battery units and the average SOC.

In some embodiments, the system includes a capacity threshold module configured to determine if a difference between the capacity of the highest capacity battery unit of the plurality of battery units and the capacity of the lowest capacity battery unit of the plurality of battery units is less than a capacity threshold, and an SOC balancing module configured to input a common current reference at the DC to DC power converter of each battery unit of the plurality of battery units in response to the difference between the capacity of the highest capacity battery unit and the capacity of the lowest capacity battery unit being below the capacity threshold.

Another apparatus for extending the life of battery units includes a control objective map (“COM”) module configured to derive a mapping between a state of charge (“SOC”) of each battery unit of a plurality of battery units with respect to an average SOC of the plurality of battery units. A highest capacity battery unit of the plurality of battery units has a highest amount of discharge between a selected SOC maximum and a selected SOC minimum and a lowest capacity battery unit of the plurality of battery units has a lowest amount of discharge between the selected SOC maximum and the selected SOC minimum. Each battery unit of the plurality of battery units connected to a shared bus through a DC to DC power converter. The system includes a delta max module configured to select a maximum SOC difference at the selected maximum SOC. The maximum SOC difference includes a difference between SOC for the highest capacity battery unit and a lowest capacity battery unit of the plurality of battery units at a selected maximum SOC for the plurality of battery units. The COM module includes a current reference module configured to derive the current reference for a battery unit of the plurality of battery units based on the maximum SOC difference, an average SOC for the plurality of battery units, the selected SOC maximum, the selected SOC minimum, a selected SOC midpoint for the plurality of battery units, a capacity of the highest capacity battery unit, a capacity of a lowest capacity battery unit, an average capacity of the plurality of battery units, a capacity of the battery unit, and a common current of the shared bus. The current reference for the battery unit of the plurality of battery units is in relation to a common current of the shared bus and the current reference for the battery unit includes a reference current for the DC to DC power converter connected to the battery unit.

In some embodiments, the apparatus includes a capacity module configured to periodically calculate a capacity of each battery unit of the plurality of battery units based on an estimated SOC, a voltage, and a current of each of the plurality of battery units. In response to calculating the capacity of each of the plurality of battery units, the delta max module adjusts the maximum SOC difference, the COM module re-derives the mapping between the SOC of each battery unit of the plurality of battery units and the average SOC. In some embodiments, the apparatus includes a capacity threshold module configured to determine if a difference between the capacity of the highest capacity battery unit of the plurality of battery units and the capacity of the lowest capacity battery unit of the plurality of battery units is less than a capacity threshold, and/or an SOC balancing module configured to input a common current reference at the DC to DC power converter of each battery unit of the plurality of battery units in response to the difference between the capacity of the highest capacity battery unit and the capacity of the lowest capacity battery unit being below the capacity threshold.

### Life-Extended Active Battery Control

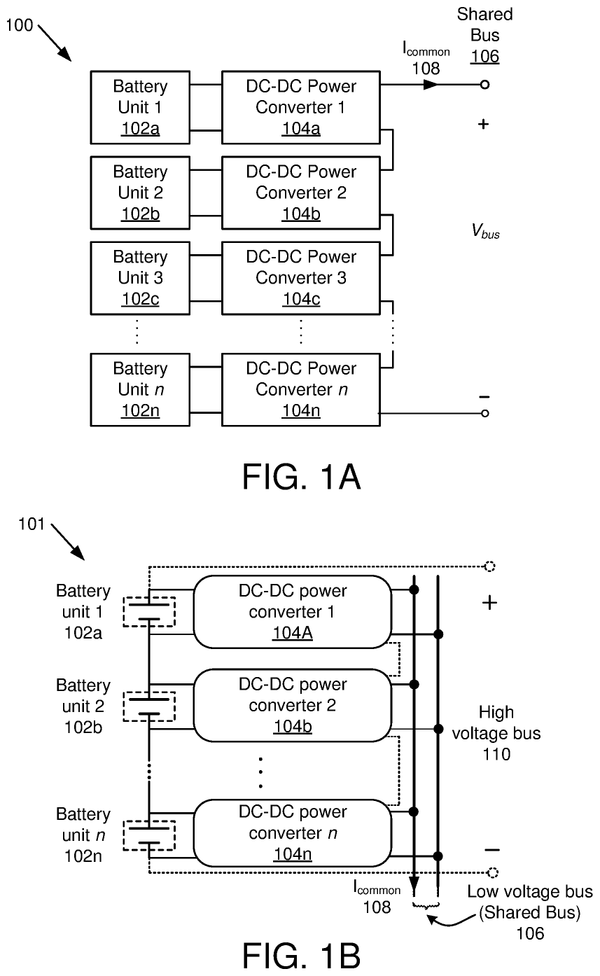

Active battery balancing control (“ABBC”) ideas presented in the '041 patent and the '066 patent is to control the control reference signal, e.g., SOC, of each battery unit in the battery system deferentially according to their states, the state of the battery system, and the control objective maps (“COMs”). The system structure, operation, and control of an ABBC system are briefly reviewed, while more details can be found in the '041 patent and the '066 patent. The high-level circuit diagram of an ABBC system is illustrated in FIG. 1B where another version is depicted in FIG. 1A where the batteries are independent and not connected in series.

FIG. 1A is a schematic block diagram illustrating a system 100 for extending the life of battery units 102a-102n (generically or collectively “102”) where the battery units 102 are independent from each other, according to various embodiments. Each battery unit 102 is connected to a direct current (“DC”) to DC power converter 104a-104n (generically or collectively “104”) where outputs of the DC to DC power converters 104 are connected in series to form a common shared bus 106 with a common current 108. In the system 100 of FIG. 1A, the battery units 102 are independent from each other. The shared bus 106 is then connected to one or more electrical devices or to a power distribution system. In some embodiments, the power distribution system or an electrical device is able to supply power to the DC to DC power converters 104, which then charge the battery units 102. During other times when power from the battery units 102 is utilized, power flows from the battery units 102, through the DC to DC power converters 104 to the shared bus 106 and to the electrical devices and/or power distribution system. The power distribution system may include a utility power system, solar panels, a hydroelectric power system, a windmill, a vehicle charging system, or the like. Load connected to the shared bus 106 may include a motor, household appliances, an industrial load, or the like.

The DC to DC power converters 104 are bidirectional and are controlled by at least a reference signal. In some embodiments, the reference signal varies to cause power to flow an attached battery unit 102 or from the battery unit 102. In some embodiments described herein, the reference signal is a current signal and represents a portion of the common current 108. While the DC to DC power converters 104 are depicted as connected in series, in other embodiments, the DC to DC power converters 104 are connected in parallel to a shared bus, as depicted in FIG. 1B.

In some embodiments, the battery units 102 are separately packaged. In other embodiments, the battery units 102 are grouped, for example, when previously used for a vehicle. In some examples, a battery pack may include four battery units 102. In some embodiments, the system 100 includes two or more battery packs, each including two or more battery units 102 and may be connected in series within the battery pack. In the embodiments of the system 100 of FIG. 1A, the battery units 102 are not connected to a load or source on the left side of FIG. 1A, even if the battery units 102 within a battery pack are series connected.

FIG. 1B is a schematic block diagram illustrating a system 101 for extending the life of battery units 102 where the battery units 102 are connected in series to form a high-voltage bus 110 and DC to DC power converters 104 connect to each battery unit 102 to provide power to a low voltage bus (e.g., shared bus 106), according to various embodiments. In the embodiments, the battery units 102 may be connected in series to form a voltage high enough to provide power to a specific load at the high-voltage bus 110. In the embodiments, the DC to DC power converters 104 are each connected to a battery unit 102 and to the shared bus 106 via a parallel connection. In some examples, the high-voltage bus 110 is connected to a motor, such as a motor of a vehicle, while the low voltage shared bus 106 is low voltage components, such as vehicle accessories. In some embodiments, the battery units 102 are charged through the DC to DC power converters 104.

The input of each DC to DC power converter 104 is connected to a battery unit 102. The battery unit can be a single battery cell or a battery module with multiple cells connected in series and/or parallel. The battery units 102 can be connected in series, parallel, or independent, while the series connection is shown in FIG. 1B. The outputs of the DC to DC power converters 104 can be connected either in parallel to a low-voltage bus or in series to a high-voltage bus 110 to provide power to the load. The shared bus 106 voltage can be controlled using a voltage map and droop control depending on the shared bus configuration, such as in the '041 patent and the '066 patent as well as other schemes.

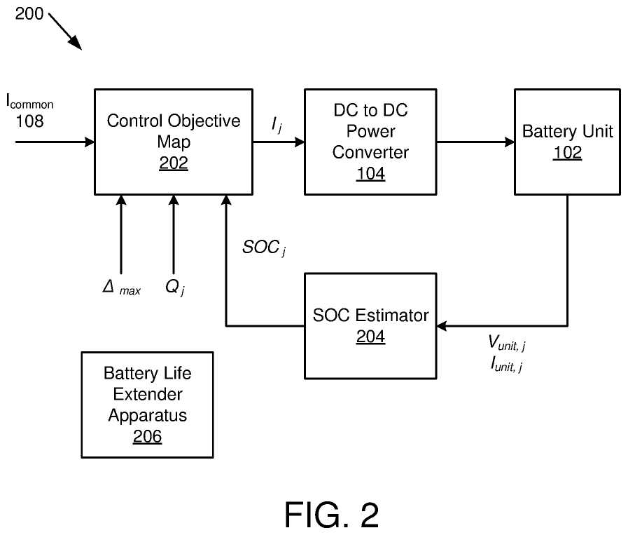

The high-level control diagram of an ABBC system is presented in FIG. 2. FIG. 2 is a schematic block diagram illustrating an ABBC 200 for a battery unit 102, according to various embodiments. The ABBC 200 is modified to include embodiments described herein. The ABBC 200 includes a control objective map (“COM”) 202 and a state of charge (“SOC”) estimator 204 in a feedback loop. Current I_{unit,j} and voltage V_{unit,j} from the battery unit 102 are input to the SOC estimator 204, which provides a state of charge estimate SOCⱼ of the battery unit 102 to the COM 202. A common current I_{common} 108 from the shared bus 106 along with a maximum SOC difference Δₘₐₓ of all of the battery units 102a-102n and capacity Qⱼ are also input to the COM 202. The COM 202 provides a current reference Iⱼ for the battery unit 102 to control the DC to DC power converter 104 to drive the state of charge of the battery unit 102 to a desired value during operation of the systems 100, 101 of FIGS. 1A or 1B.

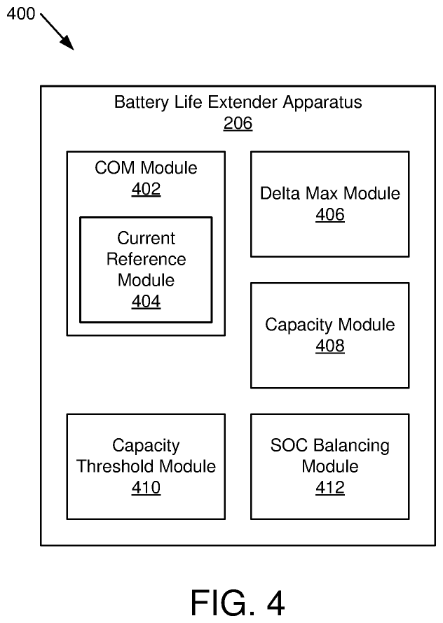

As shown in FIG. 2, the active battery balancing control system with a control objective map (“COM”) 202 takes the common current I_{common} 108, states of each battery unit 102, and state of the battery system as inputs, and outputs a current reference Iⱼ for each battery unit 102. The individual current reference Iⱼ can be either the battery unit current or the output current of the DC to DC power converter 104. The DC to DC power converter 104 regulates the battery operation according to the current reference Iⱼ, and thus, achieves the active battery balancing objectives. The battery life extender apparatus 206 provides additional controls to derive the maximum SOC difference Δₘₐₓ, derive the COM 202, determine when capacities Qⱼ for the battery units 102 are less than a capacity threshold, and the like. The battery life extender apparatus 206 is described in more detail with respect to the apparatus 400 of FIG. 4.

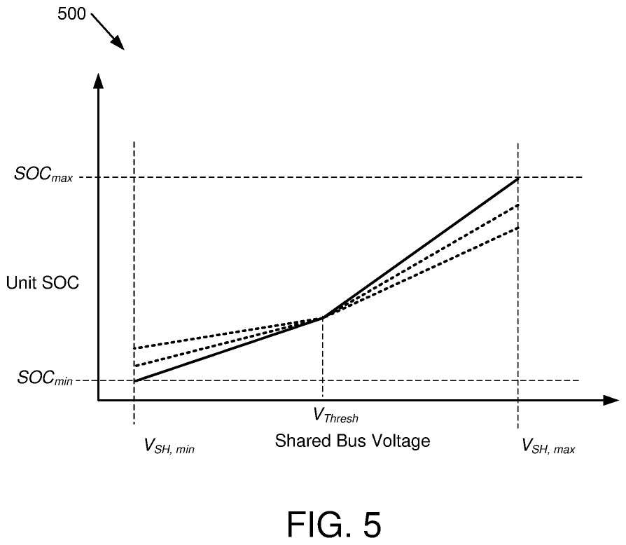

The COM shown in FIG. 5 depicts a correlation between unit SOC and shared bus voltage that can represent system average SOC. FIG. 5 is a control objective map 500 for an active battery balancing control when capacity differences between battery units 102 are below a capacity threshold, according to various embodiments. In FIG. 5, the control techniques differ when the system state is higher and lower than a control threshold, depicted as V_{Thresh}. For example, the control threshold V_{Thresh} can be a transition point from a life-optimized balancing control technique to a power-optimized balancing control technique. As shown in FIG. 5, the slopes of the control objectives change at the transition point due to the change in control technique.

Above the control threshold in the life-optimized balancing control technique, SOC dominates and is controlled to a specific value for each battery unit. Below the control threshold in the power-optimized balancing control method, the internal resistance of the battery unit becomes more of a factor to keep the battery units from dipping below the minimum allowable voltage. The life-optimized control technique is where a maximum SOC for each battery unit 102 is modified to extend the life of weaker units so that there is less of a difference in capacity between the battery units. The power-optimized balancing is to keep the open circuit voltage (“VOC”) of a battery unit 102 above a minimum voltage, which also corresponds to a minimum target SOC. If all battery units 102 within the system have the same capacity, or are within a capacity threshold, all of the battery units 102 will have the same trajectory on the COM 202, and the battery units 102 within the system 100, 101 will be balanced according to the specific control objective.

If the battery units 102 within the system 100, 101 have different capacities, each battery unit 102 will have its particular trajectory line on the COM 202, as depicted as dashed lines in FIG. 5. Each battery unit 102 will track its operating trajectory on the COM 202 and achieve the control objectives, such as optimized life and power for the battery system 100, 101.

In some embodiments, for the SOC estimation required for implementing the ABBC, a microcontroller-implemented sigma-point Kalman filter (“SPKF”)-based SOC estimation is used. Other embodiments use other methods to implement SOC estimation, for example using full-order battery equivalent circuit model and Kalman filter-based approaches. One approach for SOC estimation is described in U.S. Pat. No. 10,298,026 [hereinafter “the '026 patent”], which is incorporated herein by reference for all purposes.

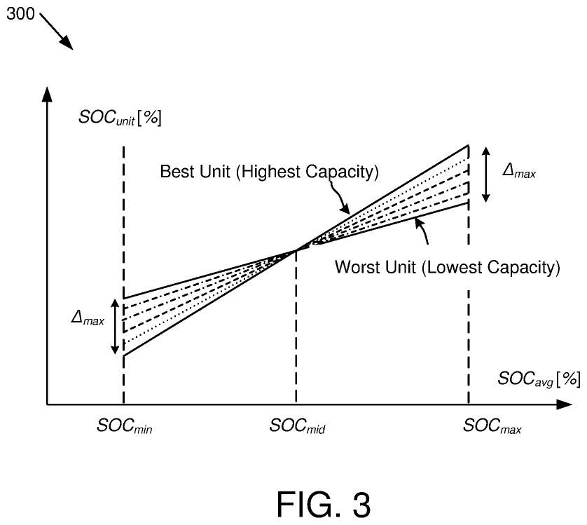

To solve the challenge of capacity imbalance in the second use of electric vehicle (“EV”)-retired batteries, the ABBC as described in embodiments herein is the life-extended ABBC technique described below. The COM 202 in FIG. 3 shows the relationship between the battery unit 102 SOC and the system average SOC. FIG. 3 is a life-extended active battery control objective map 300, according to various embodiments. As presented in FIG. 3, each battery unit 102 has a specific trajectory line related to the capacities of battery units 102 in the system and the life-extended ABBC strategy. The best battery unit 102 (highest capacity) has the widest SOC operating range, and the worst battery unit 102 (lowest capacity) has the narrowest SOC operating range. Δₘₐₓ in FIG. 3, which is the maximum SOC difference between the system's best and worst battery units, determines the aging rate difference between the best and worst battery units 102. When the capacity difference is lower than a predefined threshold (capacities of the battery units 102 in the system 100, 101 are balanced), Δₘₐₓ will be set to zero and the algorithm will follow SOC balancing COM shown in FIG. 5 without using the COM 202 of FIG. 3. Δₘₐₓ can also be a function of the capacity difference and be ramped to zero as the capacity difference becomes zero over time.

Both online and offline approaches are available for obtaining the capacity information required for the algorithm to determine the best and worst units. In some embodiments, a recursive approximate weighted total least squares estimation of battery cell total capacity is used. If online battery capacity estimation is used, in some embodiments, no prior test is used. The algorithm can start with the nominal (nameplate) capacity or other suitable capacity and is updated with the estimated capacities. Another approach is to obtain the capacities from an initial screening of the EV-retired batteries. Since battery capacity change takes time, in some embodiments, the battery life extender apparatus 206 performs periodical offline capacity checks and updates the algorithm with offline measurements.

### Available Power and Energy Analysis

Due to the capacity imbalance resulting from first-life use, life-extended ABBC is helpful for the direct second use of EV-retired batteries. As shown in FIGS. 3 and 5, the COM 202 of the life-extended ABBC strategy shows that the available power and energy are reduced compared with SOC balancing control and BESS operation without active control. To design and operate the BESS using EV-retired batteries properly, it is helpful to understand the available power and energy of the BESS with life-extended ABBC strategy. The unique and strategy-tied analysis provides the understanding of the available power and energy of BESS using life-extended ABBC strategy with relatively simple mathematical equations that require minimal computation resources and can be implemented on platforms from a computer to a low-cost microcontroller.

### A. Available Energy Analysis

Using the best battery unit 102 as a reference, from FIG. 3 the SOC trajectory of the jth battery unit 102 can be expressed as:

$$S O {C}_{j} = S O {C}_{BestUnit} + 2 {Δ}_{max} \frac{{Q}_{j} - {Q}_{max}}{{Q}_{max} - {C}_{min}} {K}_{S O C} , \qquad ( 1 )$$

where Δₘₐₓ is the maximum SOC difference between the system's best and worst battery units 102, Q represents the battery unit 102 capacity, SOC_{avg} is the measured average SOC of the battery system 100, 101, and K_{SOC} may be expressed as:

$${K}_{S O C} = \frac{S O {C}_{a v g} - S O {C}_{mid}}{S O {C}_{max} - S O {C}_{min}} \qquad ( 1 a )$$

From equations (1) and (1a), the average SOC of the battery system 100, 101 can be derived as:

$$S O {C}_{a v g} = \frac{{Σ}_{k = 1}^{N} S O {C}_{k}}{N} = S O {C}_{BestUnit} + 2 {Δ}_{max} {K}_{Q} {K}_{S O C} , \qquad ( 2 )$$

where N is the number of battery units 102 in the battery system 100, 101, Q_{avg} is the average capacity of the battery system, and K_{Q} is expressed as:

$${K}_{Q} = \frac{{Q}_{a v g} - {Q}_{max}}{{Q}_{max} - {Q}_{min}} , \qquad ( 2 a )$$

In equations (2), when SOC_{avg}=SOCₘₐₓ, the maximum average SOC of the battery system 100, 101, SOCₘₐₓ as shown in FIG. 3 can be derived as:

$$S O {C}_{max} = S O {C}_{{BestUnit}_{max}} + {Δ}_{max} {K}_{Q} , \qquad ( 3 )$$

Similarly, the minimum average SOC of the battery system, SOCₘᵢₙ, as shown in FIG. 3 can be derived as:

$$S O {C}_{min} = S O {C}_{{BestUnit}_{min}} + {Δ}_{max} {K}_{Q} , \qquad ( 4 )$$

From equations (3) and (4), the maximum available energy of the battery system E_{sys} can be derived as:

$$\begin{matrix}{E}_{sys} = {Q}_{avg} ( S O {C}_{max} - S O {C}_{min} ) \\ = {Q}_{avg} ( S O {C}_{{BestUnit}_{max}} - S O {C}_{{BestUnit}_{min}} + 2 {Δ}_{max} {K}_{Q} ) .\end{matrix} \qquad ( 5 )$$

At a given time, the available energy that the battery system 100, 101 can be charged and discharged with can be calculated as:

$${E}_{charge} = {Q}_{a v g} ( S O {C}_{a v g} - S O {C}_{max} ) , \qquad ( 6 )$$

$${E}_{discharge} = {Q}_{a v g} ( S O {C}_{a v g} - S O {C}_{min} ) , \qquad ( 7 )$$

where SOCₘₐₓ and SOCₘᵢₙ are given in equations (3) and (4) respectively.

From equations (5)-(7), it can be seen that both the battery system 100, 101 itself and the life balancing control objective design impact the system's available energy. A tradeoff between the aggressiveness of the active life balancing and the available energy, in some embodiments, is made during the design and operation of a BESS using EV-retired batteries.

### B. Available Power Analysis

For the best battery unit 102, the time needed for the SOC to change from SOC_{mid} to is maximum SOC, SOC_{BestUnitmax}, is:

$${t}_{1} = \frac{( S O {C}_{{BestUnit}_{max}} - S O {C}_{m i d} ) {Q}_{max}}{{I}_{common}} , \qquad ( 8 )$$

where I_{common} is the charging current. For other units, the time needed for the SOC to change from SOC_{mid} to its maximum SOC, SOC_{BestUnitmax}, is:

$${t}_{2} = \frac{( S O {C}_{B e {stUnit}_{max}} - {Δ}_{max} \frac{{Q}_{max} - {Q}_{j}}{{Q}_{max} - {Q}_{min}} - S O {C}_{m i d} ) {Q}_{j}}{{I}_{j}} , \qquad ( 9 )$$

where Iⱼ is the charge current for the jth battery unit 102. To track the SOC trajectory, t₁ should equal t₂. From equations (8) and (9), the jth battery unit 102 charge current Iⱼ can be derived as:

$${I}_{j} = ( 1 - \frac{{Δ}_{max}}{S O {C}_{{BestUnit}_{max}} - S O {C}_{m i d}} \frac{{Q}_{max} - {Q}_{j}}{{Q}_{max} - {Q}_{min}} ) \frac{{Q}_{j}}{{Q}_{max}} {I}_{c o m m o n} . \qquad ( 10 )$$

From equation (12), the total charge power that the battery system can have can be derived as:

$${P}_{total} = {\sum }_{k = 1}^{N} {V}_{j} {I}_{j} = {\sum }_{k = 1}^{N} [ {V}_{j} {I}_{common} \frac{{Q}_{j}}{{Q}_{max}} ( 1 - \frac{{Δ}_{max}}{S O {C}_{{BestUnit}_{max}} - S O {C}_{m i d}} \frac{{Q}_{max} - {Q}_{j}}{{Q}_{max} - {Q}_{min}} ) ] . \qquad ( 12 )$$

where Vⱼ is the voltage of a jth battery unit. Vⱼ can be the unit voltage at SOCₘᵢₙ or nominal voltage for a conservative estimation. For the discharge operation, the derivation is the same. Both the charging/discharging current and the battery unit voltage are assumed to be constant during the analysis for deriving closed-form expressions. A conservative estimation using the lowest or nominal voltage and average load current can be acceptable and significantly helpful for the BESS design, planning, management, and operation.

FIG. 4 is a schematic block diagram illustrating an apparatus 400 for extending the life of battery units, according to various embodiments. The apparatus 400 includes a battery life extender apparatus 206 with a COM module 402 with a current reference module 404, a delta max module 406, a capacity module 408, a capacity threshold module 410, and a SOC balancing module 412, which are described below. In various embodiments, the apparatus 400 is implemented using executable code stored on computer readable storage media, which is non-transitory. In other embodiments, all or a portion of the apparatus 400 is implemented using a programmable hardware device and/or hardware circuits.

The apparatus 400 includes a control objective map (“COM”) module 402 configured to derive a mapping between a state of charge (“SOC”) of each battery unit 102 of a plurality of battery units 102a-102n with respect to an average SOC of the plurality of battery units 102a-102n. FIG. 3 is a depiction of the mapping or COM 202 where SOC of the various battery units 102 is on the vertical axis and average state of charge SOC_{avg} is depicted on the horizontal axis. A highest capacity battery unit 102 of the plurality of battery units 102a-102n has a highest amount of discharge between a selected SOC maximum and a selected SOC minimum. The charge/discharge trajectory of the highest capacity battery unit 102 between the maximum and minimum SOC is depicted in FIG. 3 is the top line on the right side of FIG. 3 above the midpoint SOC and the lowest line on the on the left side of the midpoint SOC, which represents a highest amount of discharge for the battery unit 102 with the highest capacity with respect to a hypothetical battery unit 102 with the average SOC trajectory.

A lowest capacity battery unit 102 of the plurality of battery units 102a-102n has a lowest amount of discharge between the selected SOC maximum and the selected SOC minimum. The charge/discharge trajectory of the lowest capacity battery unit 102 between the maximum and minimum SOC is depicted in FIG. 3 is the bottom line on the right side of FIG. 3 above the midpoint SOC and the highest line on the on the left side of the midpoint SOC, which represents a lowest amount of discharge for the battery unit 102 with the lowest capacity with respect to a hypothetical battery unit 102 with the average SOC trajectory. Other trajectories are depicted between the highest and lowest capacity battery unit trajectories. The COM 202 of FIG. 3 is advantageous because having the higher capacity battery units 102 discharge more than average and the lower capacity battery units 102 discharge less than average eventually will narrow the differences in capacities because higher discharge/charge tends to reduce battery capacity faster than lower charge/discharge of batteries.

The battery units 102 of the COM 2 of FIG. 3 are connected to a shared bus 106 through a DC to DC power converter 104. The COM 202 provides a current reference Iⱼ for a battery unit 102 of the plurality of battery units 102a-102n in relation to a common current I_{common} 108 of the shared bus 106 and the current reference Iⱼ for the battery unit 102 is a reference current for the DC to DC power converter 104 connected to the battery unit 102. The current reference Iⱼ controls switching within the DC to DC converter to adjust current from the battery unit 102 relative the other battery units 102 of the system 100, 101.

The apparatus 400, in some embodiments, includes a delta max module 406 configured to select a maximum SOC difference Δₘₐₓ at the selected maximum SOC SOCₘₐₓ. The maximum SOC difference Δₘₐₓ is a difference between SOC for the highest capacity battery unit 102 and a lowest capacity battery unit 102 of the plurality of battery units 102a-102n at a selected maximum SOC for the plurality of battery units 102a-102n. Referring to FIG. 3, the maximum SOC SOCₘₐₓ is a SOC chosen to be a highest SOC that any of the battery units 102 will charge to. Likewise, the minimum SOC SOCₘᵢₙ is chosen to be the lowest SOC that any of the battery units 102 will discharge to. Typically, for battery health, battery units 102 are not discharged to zero or charged to 100 percent of capacity. Often a maximum SOC is in the 80 percent (%) to 95% range. Charging batteries to 100% is often harmful to batteries. Often a minimum SOC is chosen to be in the 5% to 15% range where discharging a battery to 0% is harmful to the battery. The selected maximum and minimum SOC, in some embodiments, is based on a battery type, battery health, and the like. One of skill in the art will recognize an appropriate minimum SOC and a maximum SOC for the battery units 102.

The maximum SOC difference Δₘₐₓ, in some embodiment, is selected based on how aggressive a user wants to be in narrowing a difference in capacities of the battery units 102. A higher Δₘₐₓ causes the highest battery unit 102 to charge to a greater amount more than the average SOC and to discharge to a greater amount less than the average SOC, which may affect a life the higher capacity battery units more than a less aggressive Δₘₐₓ.

In some embodiments, the delta max module 406 uses a Δₘₐₓ input by a user. In other embodiments, the delta max module 406 uses an algorithm to derive the Δₘₐₓ. In some embodiments, the delta max module 406 adjusts the maximum and minimum SOC based on the Δₘₐₓ where a more aggressive Δₘₐₓ may require a lower maximum SOC and a higher minimum SOC to accommodate the amount that the highest capacity battery unit 102 is above the average SOC.

The COM module 402 of the apparatus 400, in some embodiments, includes a current reference module 404 configured to derive the current reference If for a battery unit 102 of the plurality of battery units based on the maximum SOC difference Δₘₐₓ, an average SOC for the plurality of battery units 102a-102n, the selected SOC maximum, the selected SOC minimum, a selected SOC midpoint for the plurality of battery units 102a-102n, a capacity of the highest capacity battery unit 102, a capacity of a lowest capacity battery unit 102, an average capacity of the plurality of battery units 102, a capacity of the battery unit, and a common current I_{common} 108 of the shared bus 106.

In some embodiments, the current reference module 404 derives the current reference I_{f} as:

$${I}_{j} = {I}_{c o m m o n} ( 1 + \frac{S O {C}_{e r ror , j}}{MAX ( \vert S O {C}_{e r ror , j} \vert )} ) \qquad ( 12 )$$

$$S O {C}_{error , j} = S O {C}_{error , j} - ( S O {C}_{a v g} + \frac{2 {Δ}_{max} ( {Q}_{j} - {Q}_{a v g} )}{{Q}_{max} - {Q}_{min}} ) {K}_{S O C} \qquad ( 13 )$$

$${K}_{S O C} = \frac{S O {C}_{a v g} - S O {C}_{m i d}}{S O {C}_{max} - S O {C}_{min}} \qquad ( 14 )$$

$$S O {C}_{error , j} = S O {C}_{j} - S O {C}_{a v g} \qquad ( 15 )$$

where Δₘₐₓ is the maximum SOC difference, SOC_{avg} is the average SOC of plurality of battery units 102a-102n, SOC_{mid} is the selected SOC midpoint for the plurality of battery units 102a-102n, SOCₘₐₓ is the selected SOC maximum of plurality of battery units 102a-102n, SOCₘᵢₙ is the selected SOC minimum of plurality of battery units 102a-102n, SOCⱼ is the SOC of the battery unit 102, MAX(|SOC_{error,j}|) is the absolute value of a highest difference between an SOC of a battery unit 102 of the plurality of battery units 102a-102n and SOC_{avg}, Qₘₐₓ is the capacity of the highest capacity battery unit, Qₘᵢₙ is the capacity of the lowest capacity battery unit, Q_{avg} is the average capacity of the plurality of battery units 102a-102n, Qⱼ is the capacity of the battery unit 102, and I_{common} is the common current of the shared bus 106.

In some embodiments, the COM module 402 is configured so derive a mapping for the highest capacity battery unit 102 and a mapping for the lowest capacity battery unit 102 to have a state of charge difference matching the maximum SOC difference at the selected SOC maximum and at the selected SOC minimum and wherein the COM module 402 is further configured to derive a selected SOC midpoint where the SOC of each of the plurality of battery units 102a-102n are the same based on a calculated SOC trajectory for each of the plurality of battery units 102a-102n. In other embodiments, the COM module 402 is configured so derive a mapping for the highest capacity battery unit 102 and a mapping for the lowest capacity battery unit 102 so that the SOC of the highest capacity battery unit 102 has a highest SOC at the SOC maximum and has lowest SOC at the SOC minimum and the SOC of the lowest capacity battery unit 102 has a lowest SOC at the SOC maximum and has highest SOC at the SOC minimum, as depicted in FIG. 3.

In some embodiments, the apparatus 400 includes a capacity module 408 configured to periodically calculate a capacity of each battery unit 102 of the plurality of battery units 102a-102n based on an estimated SOC, a voltage, and a current of each of the plurality of battery units 102a-102n. In some embodiments, in response to calculating the capacity of each of the plurality of battery units 102a-102n, the delta max module 406 adjusts the maximum SOC difference Δₘₐₓ, the COM module 402 re-derives the mapping between the SOC of each battery unit 102 of the plurality of battery units 102a-102n and the average SOC. In other embodiments, the delta max module 406 does not recalculate the maximum SOC difference Δₘₐₓ so that the aggressiveness of the maximum SOC difference Δₘₐₓ remains the same, which would tend to drive the capacities of the battery units 102 closer at a faster pace than relaxing the maximum SOC difference Δₘₐₓ.

The apparatus 400, in various embodiments, includes a capacity threshold module 410 configured to determine if a difference between the capacity of the highest capacity battery unit 102 of the plurality of battery units 102a-102n and the capacity of the lowest capacity battery unit 102 of the plurality of battery units 102a-102n is less than a capacity threshold. In some embodiments, the capacities of the battery units 102a-102n differing by less than the capacity threshold signifies that the capacities are close enough to stop using the COM 202 of FIG. 3.

In some embodiments, the apparatus 400 includes an SOC balancing module 412 configured to input a common current reference at the DC to DC power converter 104 of each battery unit 102 of the plurality of battery units 102a-102n in response to the difference between the capacity of the highest capacity battery unit 102 and the capacity of the lowest capacity battery unit 102 being below the capacity threshold. Essentially, the SOC balancing module 412 stops using the COM 202 of FIG. 3 and uses the ABBC with SOC balancing of FIG. 5 or another active battery control technique where the COM 202 of FIG. 3 is not used, such as the ABBC of the '041 patent and/or the '066 patent. cl Experimental Results

To demonstrate the application of the patented ideas in BESS using EV-retired batteries and the effectiveness of the life-extended ABBC in extending the BESS life, experiments have been conducted using Nissan Leaf retired batteries. The control strategy used for the experiments is the life-extended ABBC described in the Life-Extended Active Battery Control section and presented in

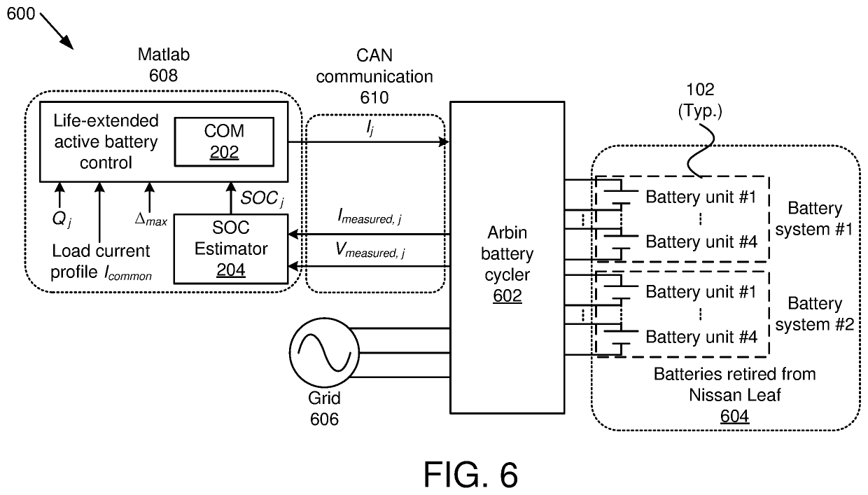

FIG. 3. FIG. 6 is a schematic block diagram illustrating a system 600 used for experimental results for demonstrating a system for extending the life of battery units 102, according to various embodiments. As shown in FIG. 6, the experimental setup has two battery systems that each include four Nissan Leaf retired battery units 604, an Arbin battery cycler 602 for charging and discharging the battery units 102, which is connected to a power grid 606, and a computer with Matlab 608 communicating with Arbin via a controller area network (“CAN”) 610 and running the life-extended ABBC strategy.

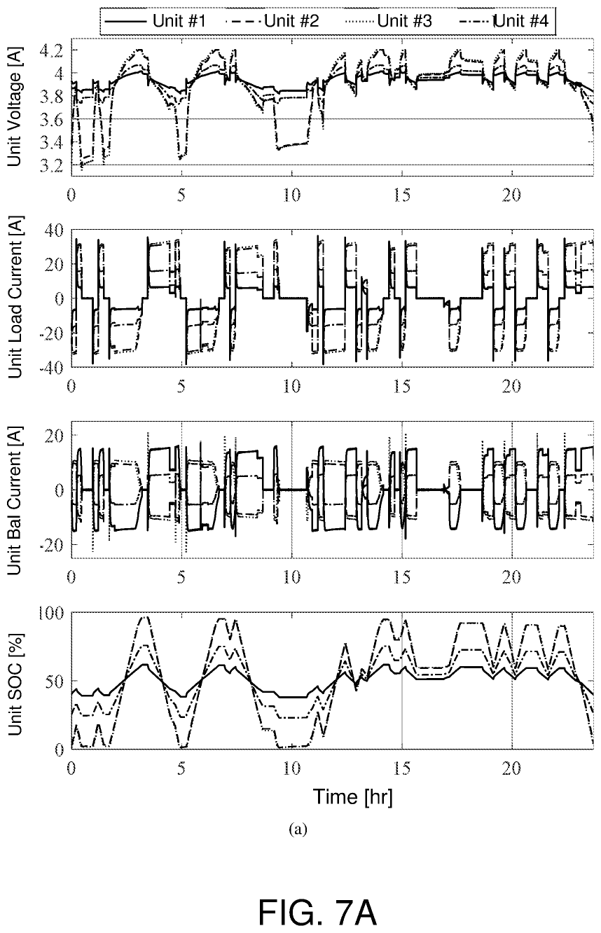

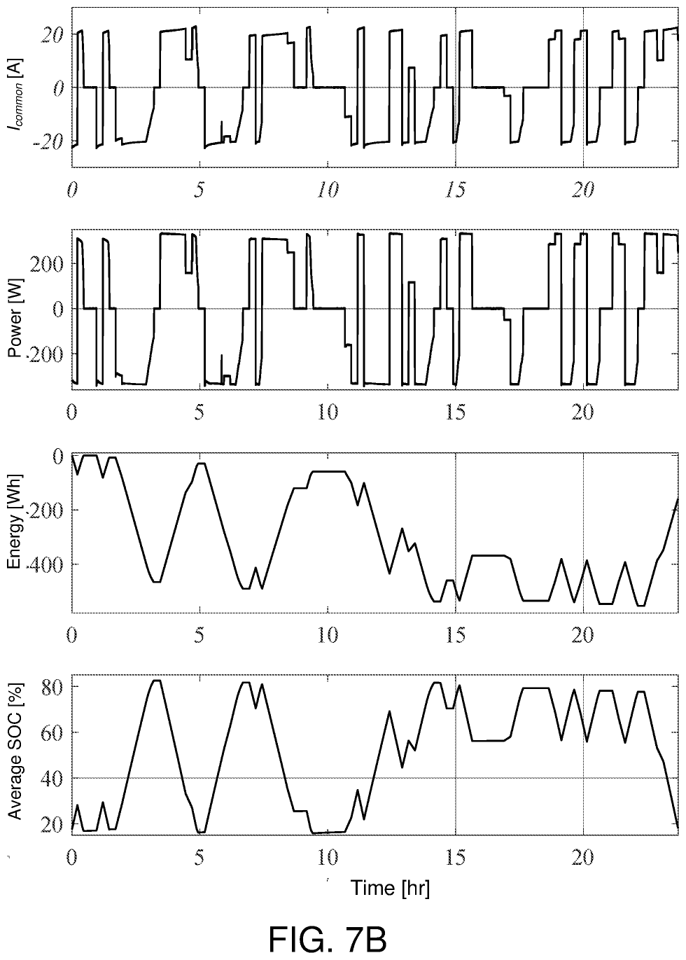

The experiments were conducted and accumulated for 50 days. During the experiments, the battery unit 102 voltage upper limit was set to 4.2 V for safety. The Δₘₐₓ was 35%. The SOC_{mid} was 50%, SOCₘᵢₙ was 15%, and SOCₘₐₓ was 85%. The SOC_{BestUnitmax} was 97% and SOC_{BestUnitmin} was 3%. Twenty-four hours' battery unit voltage, current, balancing current, and SOC data from the battery units 102 in one battery system are provided in FIG. 7A. From FIG. 7A, it can be seen that the designed life-extended ABBC strategy has been implemented as expected. The current command of each battery unit Iⱼ is calculated based on the life-extended ABBC strategy shown in FIG. 3, the SOC information of each battery unit SOCⱼ, the capacity of each battery unit Qⱼ, and the load current profile I_{common}. The derived mathematical equation for calculating each battery unit 102 current Iⱼ was derived using equations (12)-(15) as described above in relation to the current reference module 404.

In the experimental setup, the current command for each battery unit Iⱼ was calculated by the life-extended ABBC strategy in Matlab 608 and sent to the Arbin battery cycler 602 through the CAN 610, as shown in FIG. 6. The Arbin battery cycler 602 controls the actual battery unit 102 current based on the received current command Ij. For a general BESS shown in FIG. 1B, Iⱼ is the current reference of the closed-loop controller in the DC to DC power converter 104 and is controlled by the DC to DC power converter's closed-loop controller. The 24 hours of the system load current profile (I_{common}), power, accumulated energy, and average SOC data from one battery system are presented in FIG. 7B. From FIG. 7B, it can be seen that accumulated energy stays negative, meaning energy was sent to the battery system. That is because the initial SOC of the system was about 20%. The load current profile (I_{common}) was generated by using mixed-integer linear programming to dispatch energy storage resources considering revenue return in two stacked energy storage applications which are energy time shifting in the day-ahead market and real-time market. The available power and energy analysis presented in the Available Power and Energy Analysis above was considered for the load current profile generation to ensure that the life-extended ABBC strategy can be achieved throughout the experiments.

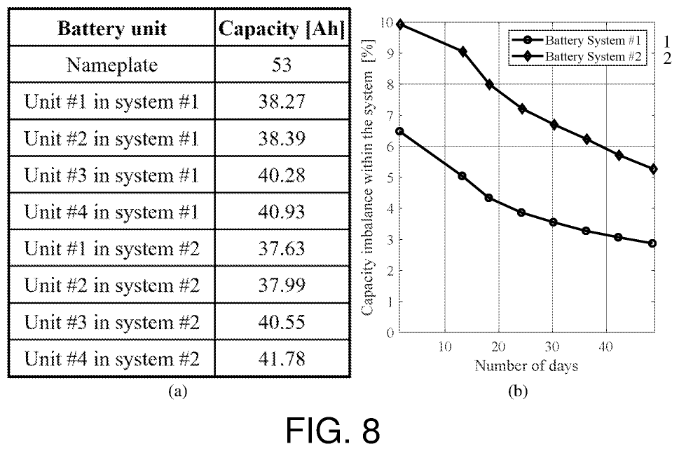

As seen in FIGS. 7A and 7B, the battery system implemented the load profile with the life-extended ABBC strategy. As shown in FIG. 7B, the maximum available energy and power of the battery system are 437 Wh and 330 W, respectively, which are much lower compared with no active balancing and SOC balancing control, as analyzed in Available Power and Energy Analysis above, considering the battery unit parameters presented in FIG. 8(a).

The initial capacities of the Nissan Leaf retired battery units 604 are provided in FIG. 8(a). The collected capacity imbalance data of the two battery systems over the 50 days of experiments are shown in FIG. 8(b). From FIG. 8(b), it can be seen that the capacity imbalance was reduced from 6.5% to 2.9% for battery system #1, and was reduced from 10% to 5.2% for battery system #2, demonstrating the effectiveness of the life-extended ABBC in reducing capacity imbalance, and thus, extending the battery system life. The offline characterization testing approach was used in this work to obtain the battery capacity information and collect the capacity imbalance data. For each data point in FIG. 8(b), the battery systems were characterized and the control algorithm was updated with the measured capacities of the battery units in the system.

Active battery balancing control improves battery capacity imbalance for the second use of EV-retired batteries due to the capacity imbalance nature of the batteries resulting from the first-life use. The proposed available power and energy analysis is helpful for researchers and engineers to understand the BESS behavior when they design, plan, manage, and operate a BESS using the patented active battery control techniques. The effectiveness of the active life balancing control in extending the lifetime of BESS using EV-retired batteries has been demonstrated using batteries retired from Nissan Leaf.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a control objective map (“COM”) module configured to derive a mapping between a state of charge (“SOC”) of each battery unit of a plurality of battery units with respect to an average SOC of the plurality of battery units, wherein a highest capacity battery unit of the plurality of battery units has a highest amount of discharge between a selected SOC maximum and a selected SOC minimum and wherein a lowest capacity battery unit of the plurality of battery units has a lowest amount of discharge between the selected SOC maximum and the selected SOC minimum,
wherein each battery unit of the plurality of battery units connected to a shared bus through a direct current (“DC”) to DC power converter,
wherein the control objective map provides a current reference for a battery unit of the plurality of battery units in relation to a common current of the shared bus, the current reference for the battery unit comprises a reference current for the DC to DC power converter connected to the battery unit,
wherein at least a portion of said modules comprise one or more of hardware circuits, programmable hardware circuits and executable code, the executable code stored on one or more computer readable storage media.

2. The apparatus of claim 1, further comprising a delta max module configured to select a maximum SOC difference at the selected maximum SOC, the maximum SOC difference comprising a difference between SOC for the highest capacity battery unit and a lowest capacity battery unit of the plurality of battery units at a selected maximum SOC for the plurality of battery units.

3. The apparatus of claim 2, wherein the COM module further comprises a current reference module configured to derive the current reference for a battery unit of the plurality of battery units based on the maximum SOC difference, an average SOC for the plurality of battery units, the selected SOC maximum, the selected SOC minimum, a selected SOC midpoint for the plurality of battery units, a capacity of the highest capacity battery unit, a capacity of a lowest capacity battery unit, an average capacity of the plurality of battery units, a capacity of the battery unit, and a common current of the shared bus.

4. The apparatus of claim 3, wherein the current reference for the battery unit is derived as:
$${I}_{j} = {I}_{c o m m o n} ( 1 + \frac{S O {C}_{e r ror , j}}{MAX ( \vert S O {C}_{e r ror , j} \vert )} ) ;$$
$$S O {C}_{error , j} = S O {C}_{error , j} - ( S O {C}_{a v g} + \frac{2 {Δ}_{max ( {Q}_{j} - {Q}_{a v g} )}}{{Q}_{max} - {Q}_{min}} ) {K}_{S O C S O C} = \frac{S O {C}_{a v g} - S O {C}_{m i d}}{S O {C}_{max} - S O {C}_{min}}$$
$$〚 S O C 〛 \_ ( error , j ) = 〚 S O C 〛 \_j - 〚 S O C 〛 \_avg ;$$
wherein:
Δₘₐₓ is the maximum SOC difference;
SOC_{avg} is the average SOC of plurality of battery units;
SOC_{mid} is the selected SOC midpoint for the plurality of battery units;
SOCₘₐₓ is the selected SOC maximum of plurality of battery units;
SOCₘᵢₙ is the selected SOC minimum of plurality of battery units;
SOCⱼ is the SOC of the battery unit;
MAX(|SOC_{error, j}|) is the absolute value of a highest difference between an SOC of a battery unit of the plurality of battery units and SOC_{avg};
Qₘₐₓ is the capacity of the highest capacity battery unit;
Qₘᵢₙ is the capacity of the lowest capacity battery unit;
Q_{avg} is the average capacity of the plurality of battery units;
Qⱼ is the capacity of the battery unit; and
I_{common} is the common current of the shared bus.

5. The apparatus of claim 2, wherein the COM module is configured to derive a mapping for the highest capacity battery unit and a mapping for the lowest capacity battery unit to have a state of charge difference matching the maximum SOC difference at the selected SOC maximum and at the selected SOC minimum and wherein the COM module is further configured to derive a selected SOC midpoint where the SOC of each of the plurality of battery units are the same based on a calculated SOC trajectory for each of the plurality of battery units.

6. The apparatus of claim 2, wherein the COM module is configured so derive a mapping for the highest capacity battery unit and a mapping for the lowest capacity battery unit so that the SOC of the highest capacity battery unit has a highest SOC at the SOC maximum and has lowest SOC at the SOC minimum and the SOC of the lowest capacity battery unit has a lowest SOC at the SOC maximum and has highest SOC at the SOC minimum.

7. The apparatus of claim 2, further comprising a capacity module configured to periodically calculate a capacity of each battery unit of the plurality of battery units based on an estimated SOC, a voltage, and a current of each of the plurality of battery units.

8. The apparatus of claim 7, wherein, in response to calculating the capacity of each of the plurality of battery units, the delta max module adjusts the maximum SOC difference, the COM module re-derives the mapping between the SOC of each battery unit of the plurality of battery units and the average SOC.

9. The apparatus of claim 7, further comprising:
a capacity threshold module configured to determine if a difference between the capacity of the highest capacity battery unit of the plurality of battery units and the capacity of the lowest capacity battery unit of the plurality of battery units is less than a capacity threshold; and
an SOC balancing module configured to input a common current reference at the DC to DC power converter of each battery unit of the plurality of battery units in response to the difference between the capacity of the highest capacity battery unit and the capacity of the lowest capacity battery unit being below the capacity threshold.

10. The apparatus of claim 7, wherein the capacity module is further configured to use a nominal capacity for a battery unit of the plurality of battery units at a start of use of the battery unit.

11. The apparatus of claim 7, wherein the capacity module is further configured to calculate an initial capacity of a battery unit of the plurality of battery units prior to use of the battery unit.

12. The apparatus of claim 1, wherein each battery unit of the plurality of battery units is a used battery unit that was previously used for a different purpose.

13. The apparatus of claim 1, wherein the shared bus is connected to provide power to and receive power from one or more electrical devices and/or an electrical distribution system.

14. A system comprising:
a plurality of battery units;
a plurality of direct current (“DC”) to DC power converter;
a shared bus comprising a common current, the shared bus configured to connect to one or more electrical devices and/or an electrical distribution system, wherein each battery unit of the plurality of battery units is connected to the shared bus through a DC to DC power converter of the plurality of DC to DC converters; and
a control objective map (“COM”) module configured to derive a mapping between a state of charge (“SOC”) of each battery unit of the plurality of battery units with respect to an average SOC of the plurality of battery units, wherein a highest capacity battery unit of the plurality of battery units has a highest amount of discharge between a selected SOC maximum and a selected SOC minimum and wherein a lowest capacity battery unit of the plurality of battery units has a lowest amount of discharge between the selected SOC maximum and the selected SOC minimum,
wherein the control objective map provides a current reference for a battery unit of the plurality of battery units in relation to the common current of the shared bus, the current reference for the battery unit comprises a reference current for the DC to DC power converter connected to the battery unit,
wherein at least a portion of said modules comprise one or more of hardware circuits, programmable hardware circuits and executable code, the executable code stored on one or more computer readable storage media.

15. The system of claim 14, further comprising a delta max module configured to select a maximum SOC difference at the selected maximum SOC, the maximum SOC difference comprising a difference between SOC for the highest capacity battery unit and a lowest capacity battery unit of the plurality of battery units at a selected maximum SOC for the plurality of battery units.

16. The system of claim 15, wherein the COM module further comprises a current reference module configured to derive the current reference for a battery unit of the plurality of battery units based on the maximum SOC difference, an average SOC for the plurality of battery units, the selected SOC maximum, the selected SOC minimum, a selected SOC midpoint for the plurality of battery units, a capacity of the highest capacity battery unit, a capacity of a lowest capacity battery unit, an average capacity of the plurality of battery units, a capacity of the battery unit, and a common current of the shared bus.

17. The system of claim 15, further comprising a capacity module configured to periodically calculate a capacity of each battery unit of the plurality of battery units based on an estimated SOC, a voltage, and a current of each of the plurality of battery units, wherein, in response to calculating the capacity of each of the plurality of battery units, the delta max module adjusts the maximum SOC difference, the COM module re-derives the mapping between the SOC of each battery unit of the plurality of battery units and the average SOC.

18. The system of claim 17, further comprising:
a capacity threshold module configured to determine if a difference between the capacity of the highest capacity battery unit of the plurality of battery units and the capacity of the lowest capacity battery unit of the plurality of battery units is less than a capacity threshold; and
an SOC balancing module configured to input a common current reference at the DC to DC power converter of each battery unit of the plurality of battery units in response to the difference between the capacity of the highest capacity battery unit and the capacity of the lowest capacity battery unit being below the capacity threshold.

19. An apparatus comprising:
a control objective map (“COM”) module configured to derive a mapping between a state of charge (“SOC”) of each battery unit of a plurality of battery units with respect to an average SOC of the plurality of battery units, wherein a highest capacity battery unit of the plurality of battery units has a highest amount of discharge between a selected SOC maximum and a selected SOC minimum and wherein a lowest capacity battery unit of the plurality of battery units has a lowest amount of discharge between the selected SOC maximum and the selected SOC minimum, wherein each battery unit of the plurality of battery units connected to a shared bus through a direct current (“DC”) to DC power converter; and
a delta max module configured to select a maximum SOC difference at the selected maximum SOC, the maximum SOC difference comprising a difference between SOC for the highest capacity battery unit and a lowest capacity battery unit of the plurality of battery units at a selected maximum SOC for the plurality of battery units,
wherein the COM module comprises a current reference module configured to derive the current reference for a battery unit of the plurality of battery units based on the maximum SOC difference, an average SOC for the plurality of battery units, the selected SOC maximum, the selected SOC minimum, a selected SOC midpoint for the plurality of battery units, a capacity of the highest capacity battery unit, a capacity of a lowest capacity battery unit, an average capacity of the plurality of battery units, a capacity of the battery unit, and a common current of the shared bus, wherein the current reference for the battery unit of the plurality of battery units is in relation to a common current of the shared bus, the current reference for the battery unit comprises a reference current for the DC to DC power converter connected to the battery unit,
wherein at least a portion of said modules comprise one or more of hardware circuits, programmable hardware circuits and executable code, the executable code stored on one or more computer readable storage media.

20. The apparatus of claim 19, further comprising:
a capacity module configured to periodically calculate a capacity of each battery unit of the plurality of battery units based on an estimated SOC, a voltage, and a current of each of the plurality of battery units, wherein, in response to calculating the capacity of each of the plurality of battery units, the delta max module adjusts the maximum SOC difference, the COM module re-derives the mapping between the SOC of each battery unit of the plurality of battery units and the average SOC;
a capacity threshold module configured to determine if a difference between the capacity of the highest capacity battery unit of the plurality of battery units and the capacity of the lowest capacity battery unit of the plurality of battery units is less than a capacity threshold; and/or
an SOC balancing module configured to input a common current reference at the DC to DC power converter of each battery unit of the plurality of battery units in response to the difference between the capacity of the highest capacity battery unit and the capacity of the lowest capacity battery unit being below the capacity threshold.
